(19) United States
(12) Patent Application Publication
(10) Pub. No.: US 2026/0094240 A1
(43) Pub. Date: Apr. 2, 2026

(54) IMAGE PROCESSING APPARATUS TO PROCESS IMAGES WITH PARALLAX, CONTROL METHOD THEREFOR, AND STORAGE MEDIUM STORING CONTROL PROGRAM THEREFOR

(71) Applicant: CANON KABUSHIKI KAISHA, Tokyo (JP)

(72) Inventor: Ryo AKAMATSU, Tokyo (JP)

(21) Appl. No.: 19/322,808

(22) Filed: Sep. 9, 2025

(30) Foreign Application Priority Data
Sep. 30, 2024 (JP) 2024-170118

(51) Int. Cl. G06T 3/60; G06T 11/60

(52) U.S. Cl. CPC G06T 3/60; G06T 11/60

(57) ABSTRACT

An image processing apparatus capable of reproducing two images with a parallax stereoscopically without a sense of discomfort. The image processing apparatus includes a processor, and a memory storing a program that causes the apparatus to obtain first and second images that capture a same object with a parallax, obtain an inclination of an image capturing apparatus around an optical axis thereof, perform a rotation correction process that rotates the first and second images to reduce the inclination, and generate an array image in which the first and second images after the rotation correction process are juxtaposed. A reduction correction process that reduces a difference between centers of the objects in the first and second images in an up-down direction after the rotation correction process and/or an erasing process that erases a portion of each of the first and second images after the rotation correction process is performed.

### BACKGROUND

### Field of the Technology

The aspect of the embodiments relates to an image processing apparatus to process images with a parallax, a control method therefor, and a storage medium storing a control program therefor.

### Description of the Related Art

There is a known technique (hereinafter referred to as a “virtual reality image display technique”) of displaying two images (an image for a left eye and an image for a right eye) having a parallax, which are captured by one camera, as virtual reality (VR) images having a stereoscopic effect. For example, Japanese Patent Laid-Open No. 2022-184712 (JP 2022-184712A, counterpart of U.S. Pat. No. 11,849,100 B2) discloses a device providing two optical systems capable of obtaining two images with a parallax. The device described in this publication inverts a left-right positional relationship between a right image and a left image juxtaposed in a left-right direction. The inversion displays the images so as to correspond to the two optical systems.

In the virtual reality image display technique, when two images are captured in a state where a camera is inclined, the images may be displayed while erasing (deleting) a portion of each of the two images. In this case, the virtual reality images may cause a sense of discomfort in reproducing (viewing) because the portion of each image is deleted.

### SUMMARY

The present disclosure provides an image processing apparatus capable of reproducing two images with a parallax stereoscopically without a sense of discomfort even when a portion of each of the two images is erased, a control method therefor, and a storage medium storing a control program therefor.

Accordingly, an aspect of the embodiments provides an image processing apparatus including a processor, and a memory storing a program which, when executed by the processor, causes the image processing apparatus to: perform an image obtaining process to obtain a first image and a second image that capture a same object and have a parallax therebetween, perform an information obtaining process to obtain inclination information related to an inclination in a case where an image capturing apparatus is rotated around an optical axis of the image capturing apparatus and inclined in capturing the first image and the second image by the image capturing apparatus, perform a correction process including a rotation correction process that rotates the first image and the second image in a direction to reduce the inclination based on the inclination information, and perform an image generation process to generate an array image in which the first image and the second image after performing the rotation correction process are juxtaposed. At least one of a reduction correction process that reduces a difference between a center of the object included in the first image and a center of the object included in the second image in an up-down direction after performing the rotation correction process and an erasing process that erases a portion of the first image and a portion of the second image after performing the rotation correction process is performed in the correction process.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic configuration diagram illustrating an example of an entire configuration in a case where an image processing apparatus related to a first embodiment is applied to a digital camera.

FIG. 2 is a block diagram illustrating an example of a hardware configuration of the digital camera.

FIG. 3 is a view illustrating an example of a mechanical configuration of a lens.

FIG. 4 is a flowchart illustrating a process executed by the camera to which the lens is mounted.

FIG. 5 is a view illustrating an example of an image captured by the camera to which the lens is mounted.

FIG. 6 is a flowchart illustrating details of a process (subroutine) executed in a step S409 of the flowchart illustrated in FIG. 4.

FIGS. 7A, 7B, and 7C are schematic views for describing an example of the process executed in the step S409 of the flowchart illustrated in FIG. 4.

FIGS. 8A and 8B are schematic views for describing an example of a process executed in a step S410 of the flowchart illustrated in FIG. 4.

FIGS. 8C, 8D, 8E, and 8F are schematic views for describing an example of an effect in the present embodiment.

FIG. 9 is a flowchart illustrating a process executed in a camera related to a second embodiment.

FIGS. 10A, 10B, 10C, and 10D are schematic views for describing an example of the process in the flowchart illustrated in FIG. 9.

FIGS. 11A and 11B are schematic views for describing an example of a process executed in a camera related to a third embodiment.

### DESCRIPTION OF THE EMBODIMENTS

Hereinafter, embodiments of the present disclosure will be described in detail with reference to the drawings. However, the configurations described in the following embodiments are merely examples, and the scope of the present disclosure is not limited by the configurations described in the embodiments. For example, each unit constituting the present disclosure can be replaced with any configuration capable of exhibiting the same function. In addition, an arbitrary constituent may be added. Any two or more configurations (features) of the embodiments can be combined.

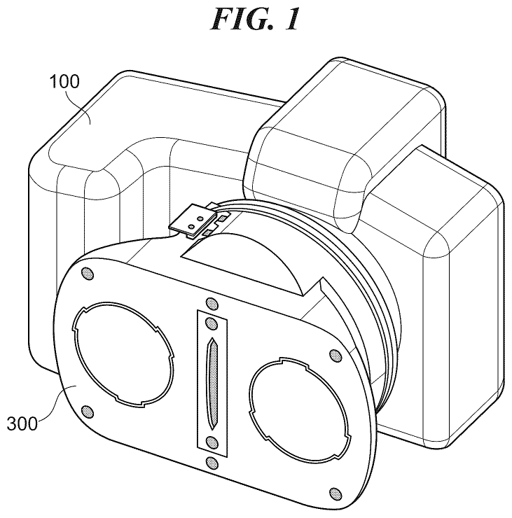

Hereinafter, a first embodiment will be described with reference to FIG. 1 to FIG. 8B. FIG. 1 is a schematic configuration diagram illustrating an example of an entire configuration in a case where an image processing apparatus related to the first embodiment is applied to a digital camera. A digital camera (hereinafter referred to as “camera”) 100 illustrated in FIG. 1 is an image capturing apparatus capable of capturing a still image and a moving image. A format of a still image may be, for example, JPEG or RAW. A format of a moving image may be, for example, MP4 or RAW. A lens 300 is detachably mounted on the camera 100. The lens 300 is a dual fisheye lens (VR180 lens) having two fisheye lenses. The lens 300 enables to capture still images or moving images as dual fisheye images having a parallax and capable of stereoscopic vision.

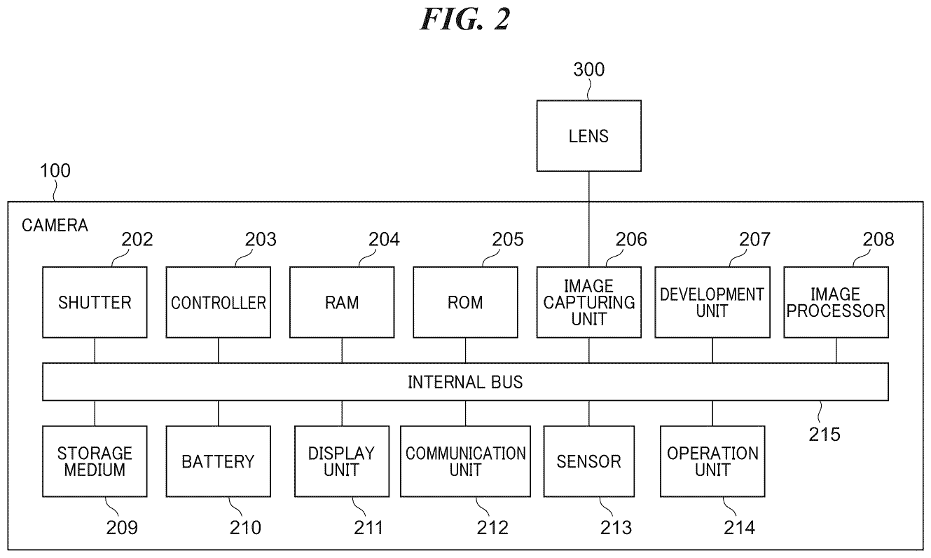

FIG. 2 is a block diagram illustrating an example of a hardware configuration of the digital camera 100. As illustrated in FIG. 2, the camera 100 includes a shutter 202, a controller 203, a RAM 204, a ROM 205, an image capturing unit 206, a development unit 207, and an image processor 208. The camera 100 includes a storage medium 209, a battery 210, a display unit 211, a communication unit 212, a sensor 213, and an operation unit 214. These hardware components included in the camera 100 are communicably connected to each other via an internal bus 215.

The shutter 202 is a focal plane shutter capable of adjusting an exposure time of the image capturing unit 206 based on the control of the controller 203. The controller 203 is a computer that includes, for example, a CPU and controls the entire camera 100. The entire control of the camera 100 may be performed by process sharing by the hardware components. The RAM 204 has a function as a buffer memory for temporarily storing various data and a function as a work area of the controller 203. The ROM 205 stores programs executed by the controller 203 and various data. The programs include, for example, a program that causes the controller 203 to execute the process (a control method for an image processing apparatus) described later.

The controller 203 controls an aperture, zoom, focus, and the like of the optical system included in the lens 300. The image capturing unit 206 includes an image sensor to convert light introduced through the optical system into an electrical image signal based on the control of the controller 203.

The development unit 207 reads image data obtained by an image capturing process and stored in the RAM 204. Then, the development unit 207 performs a development process on the image data. The development process is not particularly limited, and may be pixel interpolation, a filter process, a resize process, a color conversion process, or a format conversion process into a YCbCr format that is suitable for storage of compressed image data. The image data after the development process is stored in the RAM 204.

The image processor 208 reads the image data after the development process recorded in the RAM 204. Then, the image processor 208 performs the image process on the image data. The image process is not particularly limited, and may be a conversion process to rotate or move an image included in the image data. Further, the image data after the image process is stored in the RAM 204. The storage medium 209 stores various data. The storage medium 209 may be fixed to or built in the camera 100 in advance, or may be detachable from the camera 100.

The battery 210 is a power supply source that supplies electric power to the camera 100 to operate. The battery 210 is not particularly limited, and may be a secondary battery that can be charged by an external battery charger. The display unit 211 displays an image being captured by the image capturing unit 206 and an image stored after the image is captured. The display unit 211 also displays a menu screen on which an operation condition of the camera 100 can be set. The display unit 211 is not particularly limited, and may be a liquid crystal display.

The communication unit 212 includes, for example, an antenna and a communication controller for wireless communication. This enables communication between the camera 100 and an external apparatus. The sensor 213 is a detection unit that detects movement and a posture of the camera 100. The sensor 213 is not particularly limited, and may be an acceleration sensor and a gyrosensor. The operation unit 214 accepts a user operation. The operation unit 214 includes, for example, a power button to switch between ON and OFF of the battery 210, an image capturing start button to start capturing an image, etc. Although the camera 100 has an image capturing function and an image processing function in the present embodiment, this is not limited. For example, the camera 100 may have the image capturing function and an image processing apparatus configured separately from the camera 100 may have the image processing function.

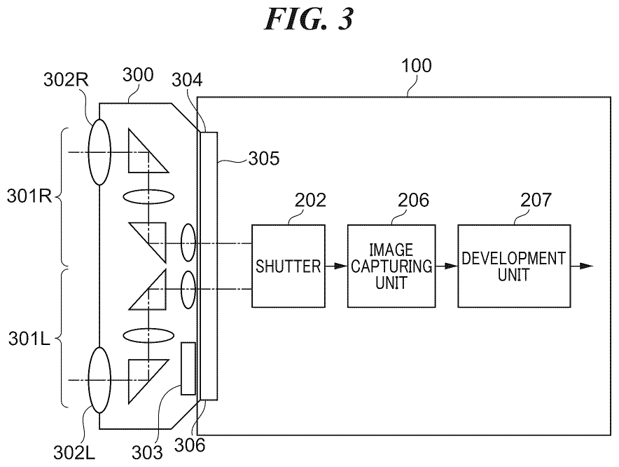

FIG. 3 is a view illustrating an example of a mechanical configuration of the lens. The lens 300 illustrated in FIG. 3 is an interchangeable lens that is attachable to and detachable from the camera 100. The lens 300 is a dual lens capable of forming images with a parallax when the same object is captured in a state of being mounted on the camera 100. The lens 300 includes a left-eye optical system 301L and a right-eye optical system 301R.

Each of the left-eye optical system 301L and the right-eye optical system 301R has a wide viewing angle of 180 degrees, and enables capturing an image in a range of a front hemisphere. Specifically, each of the left-eye optical system 301L and the right-eye optical system 301R can capture an object corresponding to a visual field (angle of view) of 180 degrees in a left-right direction (a horizontal angle, a heading angle, a yaw angle) and 180 degrees in an up-down direction (a vertical angle, an elevation/depression angle, a pitch angle). The viewing angles of the left-eye optical system 301L and the right-eye optical system 301R are not limited to 180 degrees, and may be, for example, about 160 degrees.

The left-eye optical system 301L includes a lens 302L disposed at the forefront, reflecting mirrors, and the like. The right-eye optical system 301R includes a lens 302R disposed at the forefront, reflecting mirrors, and the like. An optical axis of the lens 302L is parallel to an optical axis of the lens 302R. When the same object is captured, the lens 300 can form a right image (first image) formed through the right-eye optical system 301R and a left image (second image) having a parallax with the right image formed through the left-eye optical system 301L on the image capturing unit 206 of the camera 100.

The right image and the left image captured by the image capturing unit 206 are stored in the storage medium 209. Accordingly, the right image and the left image can be obtained (an image obtaining step, an image obtaining process). In the present embodiment, the storage medium 209 functions as an image obtaining unit that obtains the right image and the left image from the image capturing unit 206. Note that the right image and the left image are images that have passed through the lens 300, and thus are fisheye images. In the present embodiment, the right image and the left image are formed on the image capturing unit 206 side by side at the same time. That is, the right-eye optical system 301R and the left-eye optical system 301L form two optical images on the image capturing unit 206.

The image capturing unit 206 converts the formed right image and left image (optical signals) into analog electric signals. The right image and the left image are transmitted to, for example, a head-mounted display (not shown). In the head-mounted display, the right image and the left image are displayed separately. Accordingly, a user wearing the head-mounted display on one's head can appreciate a stereoscopic VR image (VR180) in a range of approximately 180 degrees.

Here, the “VR image” is an image that can be displayed as VR, which will be described later. The VR image includes, for example, an omnidirectional image (an entire celestial sphere image) captured by an omnidirectional camera (an entire celestial sphere camera), a panoramic image having an image range (an effective image range) wider than a display range that can be displayed on the display unit 211, and the like. The VR image also includes a still image, a moving image, and a live image (an image obtained in real time from the camera 100).

The VR image has an image range (an effective image range) corresponding to a visual field of 360 degrees in the left-right direction and 360 degrees in the up-down direction at the maximum. In addition, the VR image also includes an image having an angle of view wider than an angle of view that can be captured by a general camera even if the angle of view is less than 360 degrees in the left-right direction and less than 360 degrees in the up-down direction, and an image having an image range wider than a display range that can be displayed on the display unit 211. An image captured by the camera 100 using the lens 300 is a type of the VR image. The VR image is VR-displayed by setting a display mode of a display device capable of displaying the VR image such as a head-mounted display to “VR view”. When a user changes the posture of the display device in the left-right direction, that is, in the horizontal rotation direction, while VR-displaying a VR image having an angle of view of 360 degrees, the user can appreciate the omnidirectional image without a seam in the left-right direction.

Note that in this embodiment, the VR image captured using the lens 300 is a VR180 image captured in a range of 180 degrees in the forward direction, and does not include an image captured in a range of 180 degrees in the backward direction. When the VR180 image is VR-displayed and the posture of the display device is changed to a no image side, a blank region is displayed on the display device. In addition, the lens 300 includes a lens system control circuit 303 that is communicably connected to the controller 203 of the camera 100 when the lens 300 is mounted on the camera 100. The lens system control circuit 303 controls, for example, the driving of the lenses of the left-eye optical system 301L and the right-eye optical system 301R.

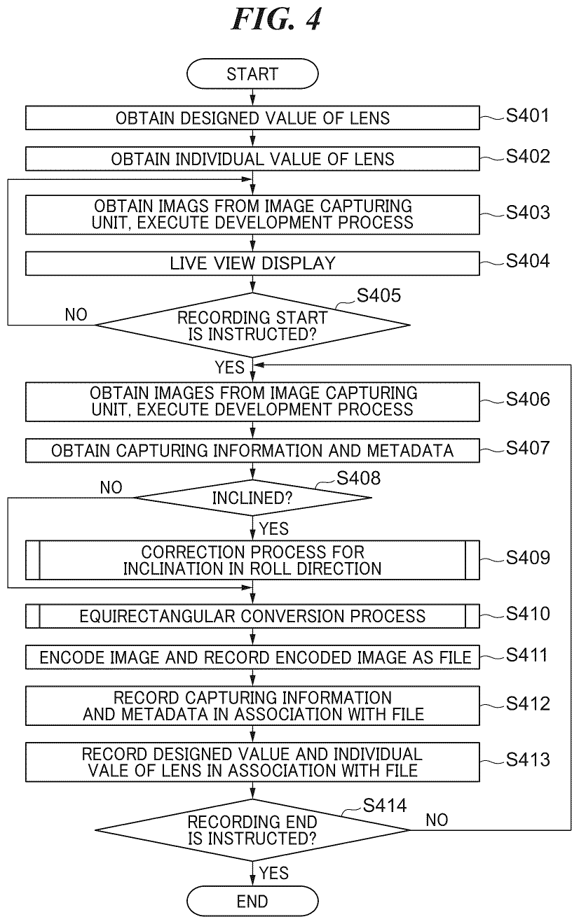

FIG. 4 is a flowchart illustrating a process executed by the camera 100 to which the lens 300 is mounted. The program based on the flowchart illustrated in FIG. 4 is started when the power button of the camera 100 is switched from an OFF state to an ON state. As illustrated in FIG. 4, in a step S401, the controller 203 of the camera 100 obtains a designed value of the lens 300 from the lens 300. The designed value of the lens 300 is stored in advance in a storage medium (not shown) incorporated in the lens 300. The designed value of the lens 300 is not particularly limited, and may be, for example, a focal length. The designed value of the lens 300 is used in an equirectangular conversion process described later.

In a step S402, the controller 203 obtains an individual value of the lens 300 from the lens 300. The individual value of the lens 300 is stored in advance in the storage medium built in the lens 300, similarly to the designed value of the lens 300. The individual value of the lens 300 is not particularly limited, and may be an error in manufacturing the lens 300. The individual value of the lens 300 is used for the equirectangular conversion process together with the designed value of the lens 300. This provides a more preferable processing result than when only the designed value of the lens 300 is used in the equirectangular conversion process.

In a step S403, the controller 203 obtains, from the image capturing unit 206, images (a right image and a left image) captured by the image capturing unit 206. After obtaining the images, the controller 203 executes a development process on the images with the development unit 207.

In a step S404, the controller 203 displays the images on which the development process has been executed in the step S403 on the display unit 211. Accordingly, the live view display is performed on the display unit 211.

In a step S405, the controller 203 determines whether a recording start of the images is instructed by a user operation to the operation unit 214. As a result of the determination in the step S405, when the controller 203 determines that the recording start is instructed, the process proceeds to a step S406. On the other hand, as a result of the determination in the step S405, when the controller 203 determines that the recording start is not instructed, the process returns to the step S403, and the subsequent steps are sequentially executed. Accordingly, the camera 100 repeats the live view display on the display unit 211 until it is determined that the recording start is instructed in the step S405. The recording start instruction may be a recording start instruction of a still image or a recording start instruction of a moving image.

In the step S406, similarly to the step S403, the controller 203 obtains images from the image capturing unit 206, and then executes the development process on the images with the development unit 207.

In a step S407, the controller 203 obtains capturing information, meta data, and the like (an information obtaining step, an information obtaining process). The capturing information is not particularly limited, and may be a shutter speed in capturing an image. The meta data is not particularly limited, and may be posture information about the camera 100 in capturing an image, that is, inclination information related to an inclination in a case where the camera 100 is rotated and inclined in a roll direction (around an optical axis of the camera 100). The posture information is obtained from the sensor 213. In this manner, in the present embodiment, the controller 203 also functions as an information obtaining unit that obtains various pieces of information. The camera 100 may have a portion functioning as the information obtaining unit separately from the controller 203. In addition, when a RAW image is captured by the camera 100, the controller 203 also obtain meta data necessary for development of the RAW image.

In a step S408, the controller 203 determines whether the camera 100 is inclined in the roll direction on the basis of the posture information obtained in the step S407. As a result of the determination in the step S408, when the controller 203 determines that the camera 100 is inclined, the inclination needs to be corrected, and the process proceeds to a step S409. On the other hand, as a result of the determination in the step S408, when the controller 203 determines that the camera 100 is not inclined, the correction for the inclination can be omitted, and the process proceeds to a step S410.

In the step S409, the controller 203 controls the image processor 208 to execute a correction process for the inclination of the camera 100 (a correction step). Details of the process in the step S409 will be described later. As described above, in the present embodiment, the controller 203 also functions as a correction unit that executes the correction process. The camera 100 may have a portion functioning as the correction unit separately from the controller 203. In addition, when the images are captured by the camera 100 inclined in the roll direction and when the correction process is omitted, the captured images are reproduced on the head-mounted display in the inclined state as-is. Therefore, the user wearing the head-mounted display may cause a sense of discomfort when viewing the images or may cause what-is-called VR sickness.

In the step S410, the controller 203 controls the image processor 208 to execute the equirectangular conversion process of converting the image on which the development process has been executed in the step S406 into a recording image. Details of the process in the step S410 will be described later.

In a step S411, the controller 203 encodes the image on which the process has been performed in the step S410. The controller 203 stores the encoded image in the storage medium 209 as a file.

In a step S412, the controller 203 records the capturing information and the meta data obtained in the step S407 in the storage medium 209 in association with the file recorded in the step S411.

In a step S413, the controller 203 records the designed value of the lens 300 obtained in the step S401 and the individual value of the lens 300 obtained in the step S402 in the storage medium 209 in association with the file recorded in step S411.

In a step S414, the controller 203 determines whether a recording end is instructed by a user operation to the operation unit 214. In the case of capturing a still image, since an image is captured one by one, the recording start and the recording end are instructed at the same time. In the case of capturing a moving image, it is assumed that the recording end is instructed when the operation unit 214 is operated again. As a result of the determination in the step S414, when the controller 203 determines that the recording end is instructed, the process ends. On the other hand, as a result of the determination in the step S414, when the controller 203 determines that the recording end is not instructed, the process returns to the step S406, and the subsequent steps are executed in order.

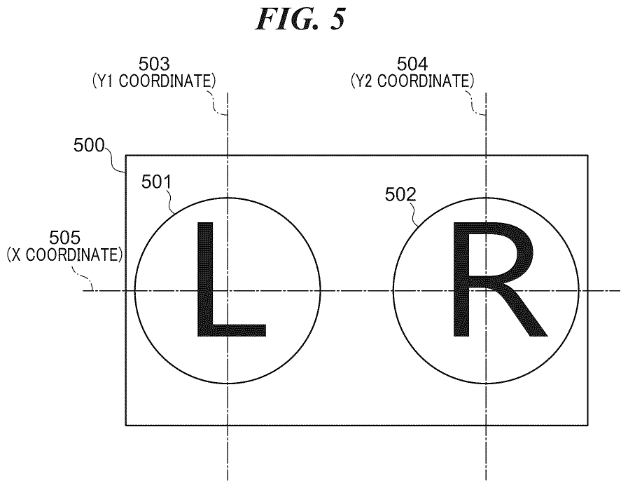

FIG. 5 is a view illustrating an example of an image captured by the camera 100 to which the lens 300 is mounted. An image 500 illustrated in FIG. 5 is stored in the RAM 204 after applying the developing process with the development unit 207. The image 500 includes a left circular fisheye image (a left image) 501 formed by the left-eye optical system 301L of the lens 300 and a right circular fisheye image (a right image) 502 formed by the right-eye optical system 301R. A line 505 (X coordinate) indicates center positions of the left circular fisheye image 501 and the right circular fisheye image 502 in the up-down direction. A line 503 (Y1 coordinate) indicates a center position of the left circular fisheye image 501 in the left-right direction. A line 504 (Y2 coordinate) indicates a center position of the right circular fisheye image 502 in the left-right direction. Therefore, the intersection of the lines 505 and 503 is the center position of the left circular fisheye image 501. The intersection of the lines 505 and 504 is the center position of the right circular fisheye image 502.

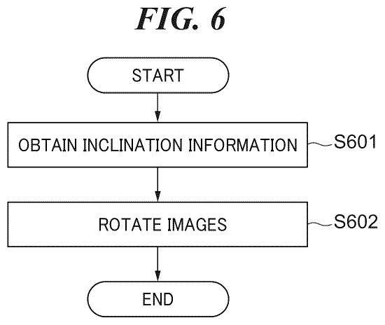

FIG. 6 is a flowchart illustrating the details of the process (subroutine) executed in the step S409 of the flowchart illustrated in FIG. 4. As illustrated in FIG. 6, in a step S601, the controller 203 obtains the inclination information related to the inclination of the camera 100 in the roll direction based on the posture information obtained in the step S407.

In a step S602, the controller 203 controls the image processor 208 to execute a rotation correction process. Specifically, the image processor 208 executes the rotation correction process of rotating the left circular fisheye image 501 and the right circular fisheye image 502 in the direction of reducing (canceling) the inclination of the camera 100 in the roll direction based on the inclination information obtained in the step S601.

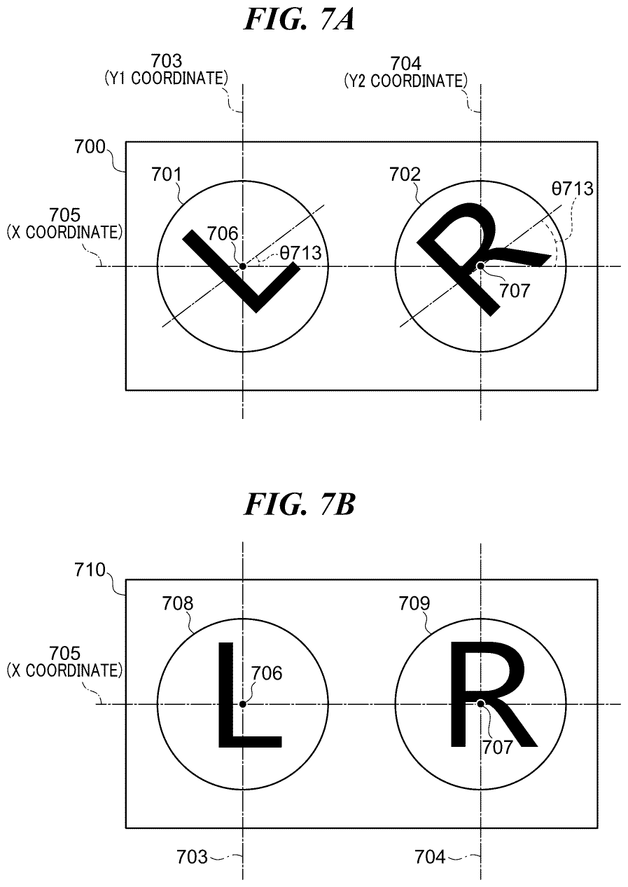

FIGS. 7A, 7B, and 7C are schematic views for describing an example of the process executed in the step S409 of the flowchart illustrated in FIG. 4. FIG. 7A is a view illustrating the circular fisheye image before performing the process. FIG. 7B is a view illustrating the circular fisheye image after performing the process. FIG. 7C is a view illustrating the posture of the camera when the circular fisheye image illustrated in FIG. 7A is captured.

An image 700 illustrated in FIG. 7A is held in the RAM 204 after the development process by the development unit 207. The image 700 is captured when it is determined that the camera 100 is inclined in the step S408. The image 700 includes a left circular fisheye image (a left image) 701 formed by the left-eye optical system 301L of the lens 300 and a right circular fisheye image (a right image) 702 formed by the right-eye optical system 301R.

A line 705 (X coordinate) indicates center positions of the left circular fisheye image 701 and the right circular fisheye image 702 in the up-down direction. A line 703 (Y1 coordinate) indicates a center position of the left circular fisheye image 701 in the left-right direction. A line 704 (Y2 coordinate) indicates a center position of the right circular fisheye image 702 in the left-right direction. An intersection 706 of the lines 705 and 703 is the center position of the left circular fisheye image 701. An intersection 707 of the lines 705 and 704 is a center position of the right circular fisheye image 702. The image 700 is captured by the camera 100 in a posture illustrated in FIG. 7C. Specifically, the camera 100 has a posture inclined counterclockwise (in the roll direction) in FIG. 7C by an angle θ712 around the optical axis of the camera 100 with respect to the horizontal direction 711 in an image capturing space.

When the rotation correction process is performed on the image 700, an image 710 illustrated in FIG. 7B is obtained. The image 710 includes a left circular fisheye image 708 and a right circular fisheye image 709. The left circular fisheye image 708 is obtained by rotating the left circular fisheye image 701 clockwise in FIG. 7B around the intersection (center position) 706 by an angle θ713 that is the same the angle θ712. The right circular fisheye image 709 is obtained by rotating the right circular fisheye image 702 clockwise in FIG. 7B around the intersection (center position) 707 by the angle θ713 that is the same as the angle θ712. The horizontal directions of the left circular fisheye image 708 and the right circular fisheye image 709 match the horizontal direction 711 in the image capturing space of the camera 100.

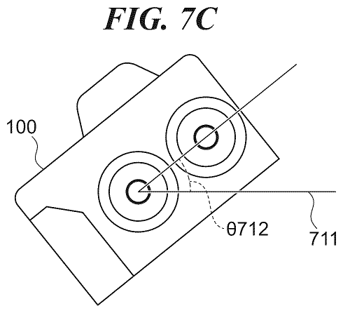

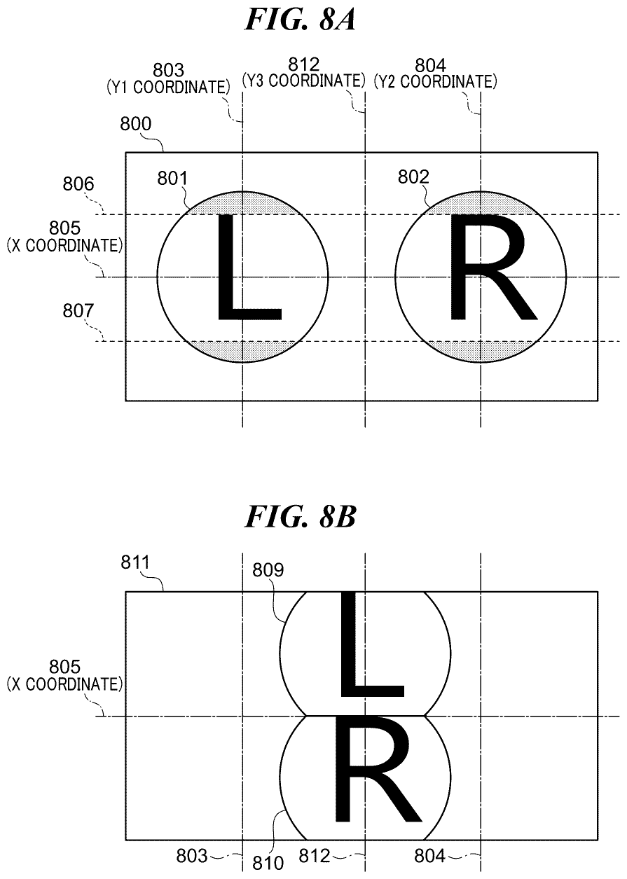

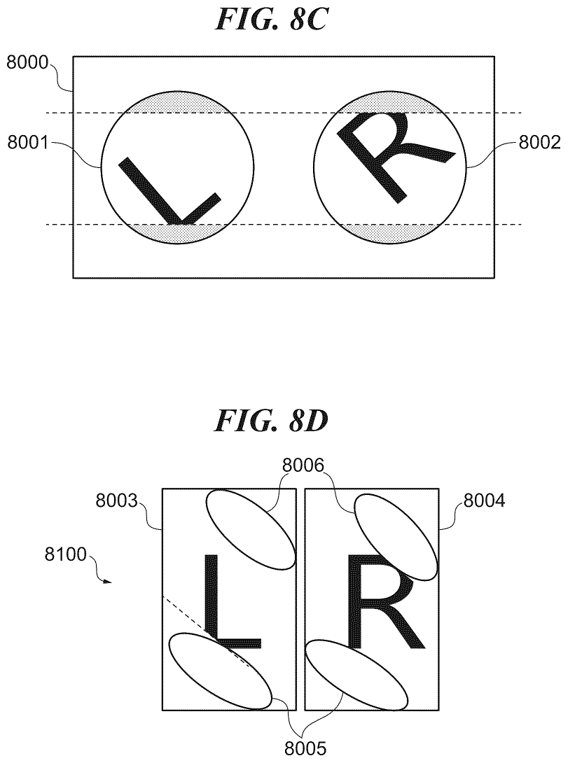

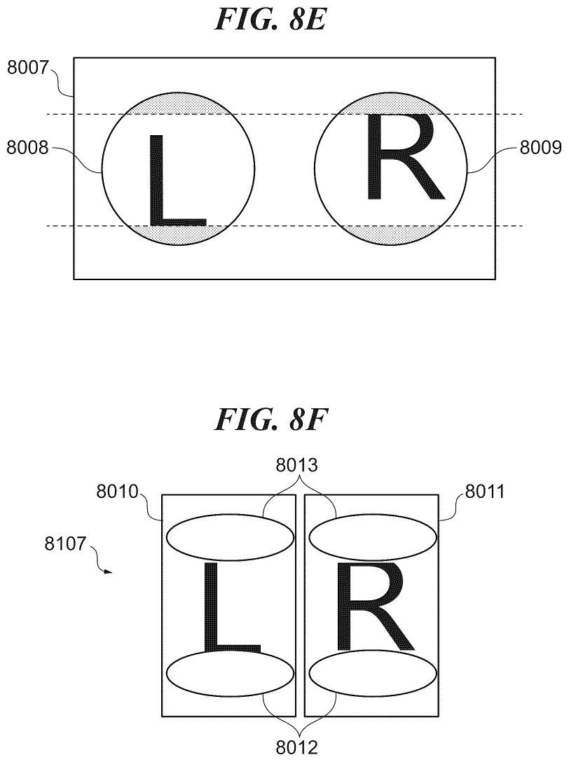

FIGS. 8A and 8B are schematic views for describing an example of the process executed in the step S410 of the flowchart illustrated in FIG. 4. FIG. 8A is a view illustrating the circular fisheye image before performing the process. FIG. 8B is a view illustrating the circular fisheye image after performing the process. The circular fisheye images after performing the process may be recorded in a “side-by-side format” in which the left circular fisheye image and the right circular fisheye image are juxtaposed in the left-right direction.

In addition, there is a “top-bottom format” in which the left circular fisheye image and the right circular fisheye image are juxtaposed in the up-down direction. In addition, when the top-bottom format is used, a portion of each of the left circular fisheye image and the right circular fisheye image may be erased (deleted), and then the circular fisheye images may be juxtaposed in the up-down direction. In this case, the circular fisheye images displayed on the head-mounted display have a narrower stereoscopically visible range than a case where no portion of each of the circular fisheye images is erased, and the data amount can be reduced and resolution feeling is maintained. The circular fisheye images are arranged in the top-bottom format after erasing a portion of each of the circular fisheye images, for example, when the processing capability of the camera 100 is insufficient or when the data amount is desired to be reduced as much as possible in streaming distribution.

An image 800 illustrated in FIG. 8A is obtained by executing the rotation correction process, similarly to the image 710 (see FIG. 7B). The image 800 includes a left circular fisheye image 801 formed by the left-eye optical system 301L of the lens 300 and a right circular fisheye image 802 formed by the right-eye optical system 301R.

A line 805 (X coordinate) indicates center positions of the left circular fisheye image 801 and the right circular fisheye image 802 in the up-down direction. A line 803 (Y1 coordinate) indicates a center position of the left circular fisheye image 801 in the left-right direction. A line 804 (Y2 coordinate) indicates a center position of the right circular fisheye image 802 in the left-right direction. A line 812 (Y3 coordinate) indicates a center position of the image 800 in the horizontal direction. A reference line 806 indicates boundaries of target areas of an erasing process for erasing upper portions of the left circular fisheye image 801 and the right circular fisheye image 802.

The portions (upper gray portions in FIG. 8A) of the left circular fisheye image 801 and the right circular fisheye image 802 upper than the reference line 806 are erased. A reference line 807 indicates boundaries of target areas of the erasing process for erasing lower portions of the left circular fisheye image 801 and the right circular fisheye image 802. The portions (lower gray portions in FIG. 8A) of the left circular fisheye image 801 and the right circular fisheye image 802 lower than the reference line 807 are erased.

Although the image processor 208 functions as an erasing unit that executes the erasing process in the present embodiment, this is not limited. For example, a portion that functions as the erasing unit may be provided separately from the image processor 208. In the present embodiment, the upper side and the lower side of each circular fisheye image are erased, but this is not limited. One of the upper side and the lower side may be erased. The positions of the reference lines 806 and 807 in the up-down direction in the image 800 can be changed by, for example, a user operation.

As illustrated in FIG. 8B, the controller 203 controls the image processor 208 to move an image 809 of the portion between the reference line 806 and the reference line 807 of the left circular fisheye image 801 to a region 811 on the RAM 204. In addition, the controller 203 controls the image processor 208 to move an image 810 of the portion between the reference line 806 and the reference line 807 of the right circular fisheye image 802 to the region 811 on the RAM 204. Then, the controller 203 controls the image processor 208 to generate an array image in which the image 809 and the image 810 are juxtaposed in the up-down direction in the region 811 (an image generation step, an image generation process). In addition, the centers of the image 809 and the image 810 in the array image are aligned on a line 812. Although the image processor 208 functions as the image generation unit that generates the array image in the present embodiment, this is not limited. For example, a portion functioning as the image generation unit may be provided separately from the image processor 208.

FIGS. 8C, 8D, 8E, and 8F are schematic views for describing an example of an effect in the present embodiment. FIG. 8C is a view illustrating the circular fisheye image before performing the process. An image 8000 illustrated in FIG. 8C is held in the RAM 204 after the development process by the development unit 207. The image 8000 is captured when it is determined that the camera 100 is inclined in the step S408. The image 8000 includes a left circular fisheye image 8001 formed by the left-eye optical system 301L of the lens 300 and a right circular fisheye image 8002 formed by the right-eye optical system 301R.

FIG. 8D is a view illustrating the circular fisheye image (a comparison example) after the equirectangular conversion process. The equirectangular conversion process includes the rotation correction process. An image 8100 shown in FIG. 8D includes a left circular fisheye image 8003 and a right circular fisheye image 8004 disposed in the side-by-side format. The image 8100 includes a region 8005 and a region 8006 that are erased by the erasing process before the left circular fisheye image 8003 and the right circular fisheye image 8004 are arranged in the side-by-side format. The region 8005 and the region 8006 each appear prominently after the equirectangular conversion process. Therefore, when the image 8100 is observed with the head-mounted display, the image 8100 may be a stereoscopic image with a sense of discomfort.

FIG. 8E is a view illustrating the circular fisheye image (embodiment) after the rotation correction process. When the rotation correction process is performed on the image 8000, an image 8007 illustrated in FIG. 8E is obtained. The image 8007 includes a left circular fisheye image 8008 and a right circular fisheye image 8009. The left circular fisheye image 8008 is obtained by rotating the left circular fisheye image 8001 clockwise in FIG. 8C by a predetermined angle. The right circular fisheye image 8009 is obtained by rotating the right circular fisheye image 8002 clockwise in FIG. 8C by the same predetermined angle.

FIG. 8F is a view illustrating the circular fisheye image (embodiment) after the equirectangular transformation process. An image 8107 shown in FIG. 8F includes a left circular fisheye image 8010 and a right circular fisheye image 8011 disposed in the side-by-side format. The image 8107 further includes a region 8012 and a region 8013 that are erased by the erasing process after the rotation correction process and before the left circular fisheye image 8010 and the right circular fisheye image 8011 are arranged in the side-by-side format. Therefore, when the image 8107 is observed with the head-mounted display, the image 8107 can be stereoscopically observed without the sense of discomfort. Even if the camera 100 having the above configuration erases a portion of each of the left circular fisheye image and the right circular fisheye image having parallax, the left circular fisheye image and the right circular fisheye image can be stereoscopically observed (reproduced) with the head-mounted display without the sense of discomfort.

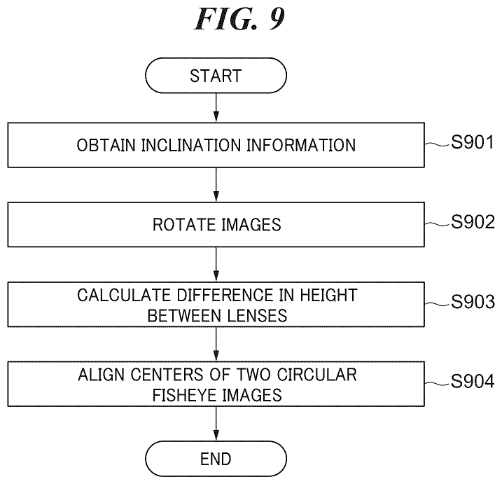

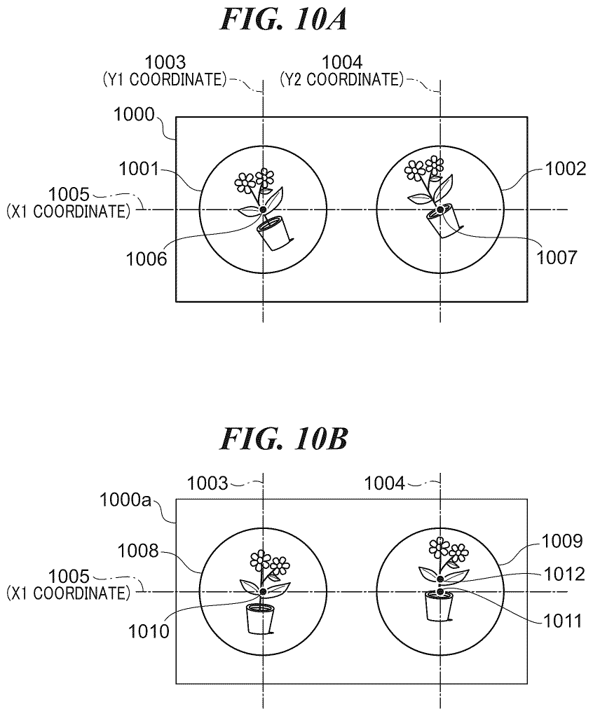

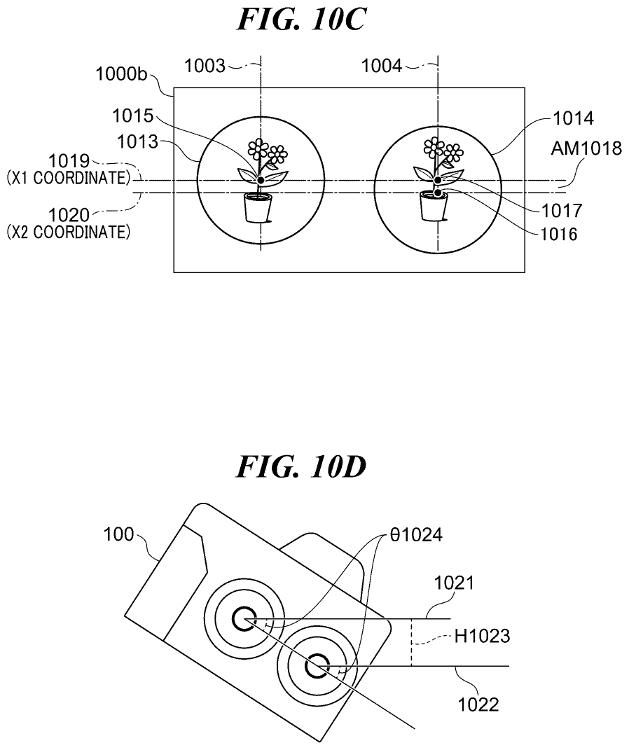

Hereinafter, a second embodiment will be described with reference to FIGS. 9, 10A, 10B, 10C, and 10D. A description will focus on differences from the above-described embodiment, and the description of the same matters will be omitted. In the present embodiment, a case where the camera 100 is inclined in the roll direction in capturing an image by the camera 100 and a significant difference in height is generated between the left-eye optical system 301L and the right-eye optical system 301R of the lens 300 will be described. FIG. 9 is a flowchart illustrating a process executed in a camera related to the second embodiment. The flowchart in FIG. 9 shows details of the process executed in the step S409 of the flowchart in FIG. 4. As illustrated in FIG. 9, in a step S901, similarly to the step S601, the controller 203 of the camera 100 obtains the inclination information related to the inclination of the camera 100 in the roll direction from the posture information obtained in the step S407.

In a step S902, similarly to the step S602, the controller 203 controls the image processor 208 to execute the rotation correction process.

In a step S903, the controller 203 calculates (computes) the difference in height between the lens 302L of the left-eye optical system 301L and the lens 302R of the right-eye optical system 301R in capturing an image based on the inclination information obtained in the step S901 and the designed value of the lens obtained in the step S401.

In a step S904, the controller 203 controls the image processor 208 to move one circular fisheye image of the two circular fisheye images in parallel along the Y coordinate by the difference in height calculated in the step S903. This aligns the centers of the two circular fisheye images.

FIGS. 10A, 10B, 10C, and 10D are schematic views for describing an example of the process in the flowchart illustrated in FIG. 9. FIG. 10A is a view illustrating the circular fisheye image before the process. FIG. 10B is a view illustrating the circular fisheye image after executing the process in the step S902. FIG. 10C is a view illustrating the circular fisheye image after executing the process in the step S904. FIG. 10C is a view illustrating the posture of the camera when the circular fisheye image illustrated in FIG. 10A is captured.

An image 1000 illustrated in FIG. 10A is stored in the RAM 204 after applying the developing process with the development unit 207. The image 1000 is captured when it is determined that the camera 100 is inclined in the step S408. The image 1000 includes a left circular fisheye image 1001 formed by the left-eye optical system 301L of the lens 300 and a right circular fisheye image 1002 formed by the right-eye optical system 301R.

A line 1005 (X coordinate) indicates center positions of the left circular fisheye image 1001 and the right circular fisheye image 1002 in the up-down direction. A line 1003 (Y1 coordinate) indicates a center position of the left circular fisheye image 1001 in the left-right direction. A line 1004 (Y2 coordinate) indicates a center position of the right circular fisheye image 1002 in the left-right direction. An intersection 1006 of the lines 1005 and 1003 is the center position of the left circular fisheye image 1001. An intersection 1007 of the lines 1005 and 1004 is a center position of the right circular fisheye image 702.

The image 1000 is captured by the camera 100 in a posture illustrated in FIG. 10D. Specifically, the camera 100 has a posture inclined counterclockwise (in the roll direction) in FIG. 10D by an angle θ1024 around the optical axis of the camera 100 with respect to the horizontal direction 1021 and the horizontal direction 1022 in the image capturing space. A height difference H1023 is a difference in height between the left-eye optical system 301L and the right-eye optical system 301R.

By executing the process (rotation correction process) in the step S902 on the image 1000, an image 1000a illustrated in FIG. 10B is obtained. The image 1000a includes a left circular fisheye image 1008 and a right circular fisheye image 1009. The left circular fisheye image 1008 is obtained by rotating the left circular fisheye image 1001 clockwise in FIG. 10B around the intersection (center position) 1010 by an angle equal to the angle θ1024. The right circular fisheye image 1009 is obtained by rotating the right circular fisheye image 1002 clockwise in FIG. 10B around the intersection (center position) 1011 by an angle equal to the angle θ1024. A point 1012 in the right circular fisheye image 1009 corresponds to the intersection 1010. In addition, both the horizontal directions of the left circular fisheye image 1008 and the right circular fisheye image 1009 match the horizontal direction 1021 (the horizontal direction 1022) in the image capturing space of the camera 100. However, since the center position of the image capturing target (object) in the left circular fisheye image 1008 is different from that in the right circular fisheye image 1009, these images may not be converted into stereoscopic images that are observed with the head-mounted display without a sense of discomfort.

By executing the process in the step S904 on the image 1000a, an image 1000b illustrated in FIG. 10C is obtained. The image 1000b includes a left circular fisheye image 1013 and a right circular fisheye image 1014 after the movement. A position 1015 indicates the center of the left circular fisheye image 1013. A position 1017 indicates the center of the right circular fisheye image 1014 after the movement. A line 1019 (X1 coordinate) is similar to the line 1005 (X1 coordinate). A line 1020 (X2 coordinate) indicates the center position of the right circular fisheye image 1014 after the movement.

A moving amount AM1018 is up-down direction information about the difference in the up-down direction between the center of the right circular fisheye image 1014 (object) and the center of the left circular fisheye image 1013 (object), and is calculated on the basis of the height difference H1023. Then, a reduction correction process to reduce the height difference H1023 is executed on the basis of the moving amount AM1018, and the original center 1016 of the right circular fisheye image 1014 is moved by the moving amount AM1018. As a result, the center 1015 of the left circular fisheye image 1013 and the center 1017 of the right circular fisheye image 1014 are aligned (matched) in the up-down direction. Accordingly, even when a significant difference in height occurs between the left-eye optical system 301L and the right-eye optical system 301R, the images can be stereoscopically observed with the head-mounted display without a sense of discomfort.

Although the right circular fisheye image after the movement is obtained with reference to the center of the left circular fisheye image in the present embodiment, this is not limited. For example, the right circular fisheye image may be used as a reference, or each circular fisheye image may be moved using the middle between the center of the left circular fisheye image and the center of the right circular fisheye image as a reference.

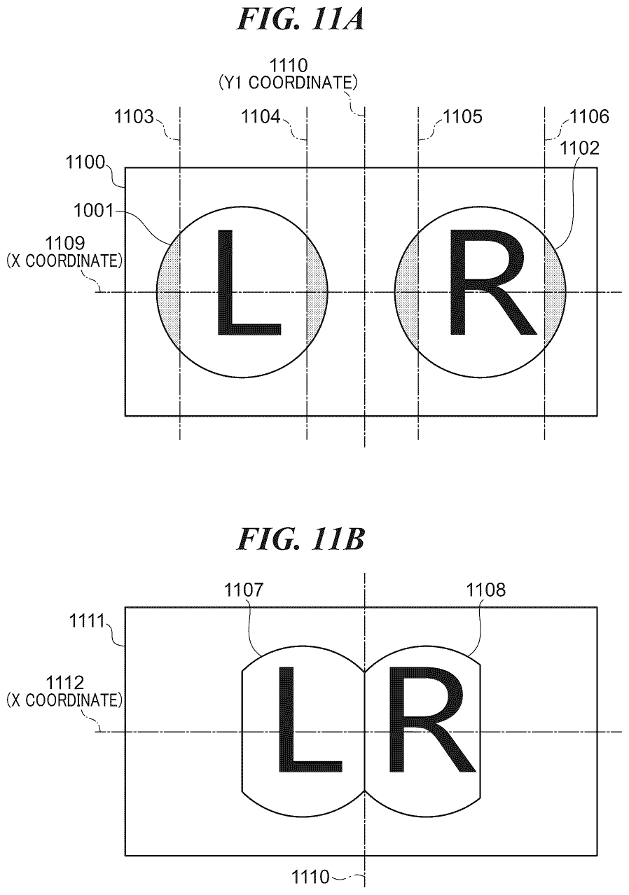

Hereinafter, a third embodiment will be described with reference to FIGS. 11A and 11B. A description will focus on differences from the above-described embodiment, and the description of the same matters will be omitted. In the present embodiment, a case where a left circular fisheye image and a right circular fisheye image are juxtaposed in the left-right direction will be described. FIGS. 11A and 11B are schematic views for describing an example of a process executed in a camera related to a third embodiment. Specifically, FIGS. 11A and 11B are schematic views for describing an example of a process executed in the step S410 of the flowchart in FIG. 4. FIG. 11A is a view illustrating the circular fisheye image before the process. FIG. 11B is a view illustrating the circular fisheye image after performing the process. An image 1100 shown in FIG. 11A is obtained by executing the rotation correction process.

The image 1100 includes a left circular fisheye image 1101 formed by the left-eye optical system 301L of the lens 300 and a right circular fisheye image 1102 formed by the right-eye optical system 301R. A line 1109 (X coordinate) indicates center positions of the left circular fisheye image 1101 and the right circular fisheye image 1102 in the up-down direction. A line 1110 (Y coordinate) indicates a center position of the image 1100 in the left-right direction.

A reference line 1103 indicates a boundary of a target area of the erasing process for erasing a left portion of the left circular fisheye image 1101. The left side than the reference line 1103 of the left circular fisheye image 1101 is erased. A reference line 1104 indicates a boundary of a target area of the erasing process for erasing a right portion of the left circular fisheye image 1101. The right side than the reference line 1104 of the left circular fisheye image 1101 is erased.

A reference line 1105 indicates a boundary of a target area of the crasing process for erasing a left portion of the right circular fisheye image 1101. The left side than the reference line 1105 of the right circular fisheye image 1102 is erased. A reference line 1106 indicates a boundary of a target area of the erasing process for crasing a right portion of the right circular fisheye image 1102. The right side than the reference line 1106 of the right circular fisheye image 1102 is erased. Although the left side and the right side of each circular fisheye image are erased in the present embodiment, this is not limited. One of the left side and the right side may be erased. The positions of the reference lines 1103 to 1106 in the left-right direction in the image 1100 can be changed by, for example, a user operation.

As illustrated in FIG. 11B, the controller 203 controls the image processor 208 to move an image 1107 of the portion between the reference lines 1103 and 1104 of the left circular fisheye image 1101 to a region 1111 on the RAM 204. The controller 203 controls the image processor 208 to move an image 1108 of the portion between the reference lines 1105 and 1106 of the right circular fisheye image 1102 to the region 1111 on the RAM 204. Then, the controller 203 controls the image processor 208 to generate an array image in which the image 1107 and the image 1108 are juxtaposed in the left-right direction in the region 1111 (an image generation step, an image generation process). In addition, in the array image, the centers of the image 1107 and the image 1108 are aligned on a line 1112. When the image 1107 and the image 1108 are observed on the head-mounted display, the images can be stereoscopically viewed without a sense of discomfort.

Although the preferred embodiments of the present disclosure have been described above, the present disclosure is not limited to the above-described embodiments, and various modifications and changes can be made within the scope of the gist of the present disclosure. For example, the two circular fisheye images of which the right and left portions are erased may be arranged in the top-bottom format instead of the side-by-side format. The two circular fisheye images of which the upper and lower portions are erased may be arranged in the side-by-side format instead of the top-bottom format.

According to the present disclosure, even if a portion of each of two images having parallax is erased, the images can be reproduced so as to be stereoscopically viewed without a sense of discomfort.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-170118, filed Sep. 30, 2024 which is hereby incorporated by reference herein in its entirety.

What is claimed is:

1. An image processing apparatus comprising:
a processor; and
a memory storing a program which, when executed by the processor, causes the image processing apparatus to:
perform an image obtaining process to obtain a first image and a second image that capture a same object and have a parallax therebetween;
perform an information obtaining process to obtain inclination information related to an inclination in a case where an image capturing apparatus is rotated around an optical axis of the image capturing apparatus and inclined in capturing the first image and the second image by the image capturing apparatus;
perform a correction process including a rotation correction process that rotates the first image and the second image in a direction to reduce the inclination based on the inclination information; and
perform an image generation process to generate an array image in which the first image and the second image after performing the rotation correction process are juxtaposed,
wherein at least one of a reduction correction process that reduces a difference between a center of the object included in the first image and a center of the object included in the second image in an up-down direction after performing the rotation correction process and an erasing process that erases a portion of the first image and a portion of the second image after performing the rotation correction process is performed in the correction process.

2. The image processing apparatus according to claim 1, wherein up-down direction information about a difference between the center of the object included in the first image and the center of the object included in the second image in the up-down direction caused by the inclination is obtained in the information obtaining process; and
the difference is reduced based on the up-down direction information in the reduction correction process.

3. The image processing apparatus according to claim 2, wherein a position of a center of the object included in one of the first image and the second image in the up-down direction is aligned to a position of a center of the object included in another image in the up-down direction in the reduction correction process after the rotation correction process.

4. The image processing apparatus according to claim 1, wherein at least one of an upper portion and a lower portion of each of the first image and the second image after the rotation correction process is erased in the erasing process prior to generation of the array image.

5. The image processing apparatus according to claim 1, wherein at least one of a left portion and a right portion of each of the first image and the second image after the rotation correction process is erased in the erasing process prior to generation of the array image.

6. The image processing apparatus according to claim 1, wherein an image in which the first image and the second image are juxtaposed in the up-down direction is generated as the array image in the image generation process.

7. The image processing apparatus according to claim 1, wherein an image in which the first image and the second image are juxtaposed in the left-right direction is generated as the array image in the image generation process.

8. The image processing apparatus according to claim 1, wherein fisheye images are obtained as the first image and the second image in the image obtaining process.

9. The image processing apparatus according to claim 1, wherein the image processing apparatus comprises an image capturing apparatus that performs an image capturing process to capture the first image and the second image,
the first image and the second image are obtained by the image capturing process in the image obtaining process.

10. A control method for an image processing apparatus, the control method comprising:
performing an image obtaining process to obtain a first image and a second image that capture a same object and have a parallax therebetween;
performing an information obtaining process to obtain inclination information related to an inclination in a case where an image capturing apparatus is rotated around an optical axis of the image capturing apparatus and inclined in capturing the first image and the second image by the image capturing apparatus;
performing a correction process including a rotation correction process that rotates the first image and the second image in a direction to reduce the inclination based on the inclination information; and
performing an image generation process to generate an array image in which the first image and the second image after performing the rotation correction process are juxtaposed,
wherein at least one of a reduction correction process that reduces a difference between a center of the object included in the first image and a center of the object included in the second image in an up-down direction after performing the rotation correction process and an erasing process that erases a portion of the first image and a portion of the second image after performing the rotation correction process is performed in the correction process.

11. A non-transitory computer-readable storage medium storing a control program causing a computer to execute a control method for an image processing apparatus, the control method comprising:
performing an image obtaining process to obtain a first image and a second image that capture a same object and have a parallax therebetween;
performing an information obtaining process to obtain inclination information related to an inclination in a case where an image capturing apparatus is rotated around an optical axis of the image capturing apparatus and inclined in capturing the first image and the second image by the image capturing apparatus;
performing a correction process including a rotation correction process that rotates the first image and the second image in a direction to reduce the inclination based on the inclination information; and
performing an image generation process to generate an array image that arranges the first image and the second image after performing the rotation correction process side by side,
wherein at least one of a reduction correction process that reduces a difference between a center of the object included in the first image and a center of the object included in the second image in an up-down direction after performing the rotation correction process and an erasing process that erases a portion of the first image and a portion of the second image after performing the rotation correction process is performed in the correction process.
